(19) United States
(12) Patent Application Publication
(10) Pub. No.: US 2024/0320529 A1
(43) Pub. Date: Sep. 26, 2024

(54) MULTI-STAGE WATERMARKING OF A DIGITAL OBJECT GENERATED BY A MACHINE LEARNING MODEL

(71) Applicant: DeepMind Technologies Limited, London (GB)

(72) Inventors: Sumanth Dathathri, London (GB); Abigail Elizabeth See, London (GB); Borja De Balle Pigem, London (GB); Sumedh Kedar Ghaisas, London (GB); Pushmeet Kohli, London (GB); Po-Sen Huang, London (GB); Johannes Maximilian Welbl, London (GB)

(21) Appl. No.: 18/611,417

(22) Filed: Mar. 20, 2024

(30) Foreign Application Priority Data
Mar. 20, 2023 (EP) 23162983.3

(51) Int. Cl. G06N 7/01

(52) U.S. Cl. CPC G06N 7/01

(57) ABSTRACT

Methods, systems, and apparatus, including computer programs encoded on computer storage media, for watermarking a digital object generated by a machine learning model. The digital object is defined by a sequence of tokens. The watermarking involves modifying a probability distribution of the tokens by applying a succession of watermarking stages.

### CROSS-REFERENCE TO RELATED APPLICATION

This application is based upon and claims the benefit of priority of the prior European Patent Application No. 23162983.3, filed on Mar. 20, 2023, the entire contents of which is incorporated herein by reference.

### BACKGROUND

This specification relates to digitally watermarking the output of machine learning models.

Machine learning models can be trained to generate a digital object, such as a passage of text or an image. Some machine learning models are parametric models and generate the output based on values of the parameters of the model. Neural networks are machine learning models that employ one or more layers of nonlinear units; deep neural networks include one or more hidden layers in addition to an output layer. Each layer of the network generates an output in accordance with current values of a respective set of parameters.

Some machine learning models generate elements of the output, herein referred to as tokens, one at a time, e.g., by sampling from a probability distribution determined by the model. Some of these models are autoregressive models, that generate a new output element, or token, conditioned on the output elements, or tokens, that have already been generated.

### SUMMARY

This specification describes a method and a corresponding system, implemented as computer programs on one or more computers in one or more locations, that can watermark a digital object generated by a machine learning model. The digital object can be, e.g., a piece of text, a still or moving image, or an object representing an audio waveform, or a combination of these. The watermarking can be detected, and so it can be determined whether or not a digital object was generated by the machine learning model.

In one aspect there is described a computer-implemented method of watermarking a digital object defined by a sequence of tokens. The method generates each token of the sequence of tokens by processing one or more preceding tokens in the sequence using a trained machine learning model, in particular an autoregressive machine learning model, to determine an initial probability distribution over possible tokens for a current token in the sequence. The method determines, more particularly selects, the current token in the sequence in accordance with a modified probability distribution over the possible tokens. The tokens may comprise, e.g., natural language tokens, such as words or wordpieces, or tokens defining image pixels or regions, or tokens characterizing an audio waveform.

In implementations the current token in the sequence is selected using a process that involves a plurality of watermarking stages, applied iteratively. More specifically each watermarking stage comprises applying, to a representation of, or to samples from, a probability distribution associated with the watermarking stage, a modification based on a respective pseudorandom function for the watermarking stage. The pseudorandom function is a function of one or more of the preceding tokens in the sequence and a supposed, i.e., possible or postulated, current token.

The probability distribution associated with a first of the watermarking stages is the initial probability distribution. The modification applied in a last of the watermarking stages results in a representation of, or sample from, the modified probability distribution.

In implementations, the pseudorandom function, which is different for each iteration, is a function of n preceding tokens (x_{<t}), where n may be all the preceding tokens, and the supposed current token (sₜ; x′ₜ), and a score or value for the supposed token. In some implementations, but not necessarily, the value is a binary value, {0,1}. In implementations the pseudorandom function depends on a key that is different for each iteration. That is, the pseudorandom function for each iteration may be different because it is based on, i.e., modified by, a different key, but apart from the key the pseudorandom function for each iteration may be the same. The pseudorandom function may comprise a cryptographic function such as a hash function.

The pseudorandom functions modify the probability distribution associated with a watermarking stage so that knowledge of the pseudorandom functions allows detection of whether or not the pseudorandom functions were used to generate the sequence of tokens, i.e., detection of whether or not the sequence of tokens is watermarked.

The modification applied by the pseudorandom functions may be applied in various ways, as described later. In general the modification biases the token distribution towards a secret distribution determined by the pseudorandom functions, that is it biases the generation of tokens, in particular selection of the current token, to generate a sequence of tokens defining the digital object that scores higher when a score for the generated sequence of tokens is determined using the same pseudorandom functions. In general selection of the current token is by evaluating, directly or indirectly, multiple supposed current tokens to select a token for the sequence of tokens defining the digital object.

For example the pseudorandom functions can be evaluated for multiple supposed (possible) current tokens (and the same n preceding tokens). The current token can be selected based on the supposed token so that the sequence of tokens defining the digital object is biased towards a higher value or score when evaluated using the same respective pseudorandom functions.

In some implementations the current token is selected as a supposed current token that biases the value or score from the respective pseudorandom functions towards a higher value. In some implementations the supposed current token that biases the value or score from the respective pseudorandom functions towards a higher value provides a current token for a draft sequence, which can then either be accepted or rejected for use in the sequence of tokens defining the digital object, e.g., based on a second, e.g., larger, trained machine learning model

The respective pseudorandom functions are evaluated over the one or more of the preceding tokens in the sequence and the selected current token (which may be the selected current token for the draft sequence). That is the value or score from the respective pseudorandom functions that is biased towards a higher value can be that from the sequence comprising the current token and the n preceding tokens, e.g., determined as a sum of the value or score from each of the pseudorandom functions.

As one example a plurality of supposed current tokens can be drawn from the initial probability distribution and then evaluated in a knockout tournament in which in each round, i.e., at each iteration, the token with the largest score survives (breaking ties randomly), until there is one winner. As another example, a probability distribution for such a winning token can be derived directly from an iterative calculation, without running the tournament. In some implementations, the supposed current token may be one that (amongst a plurality of possibilities for the supposed current token) maximizes a score or value from the respective pseudorandom functions.

In some implementations applying the modification to the probability distribution associated with the watermarking stage comprises selecting one or more of the samples from the probability distribution associated with the watermarking stage.

In some implementations applying the modification to the probability distribution associated with the watermarking stage involves modifying a representation of the probability distribution associated with the watermarking stage. Then the modification applied in the last watermarking stage results in a representation of the modified probability distribution over the possible tokens, and selecting the current token involves sampling from this distribution.

In some implementations the above described techniques are applied when generating a draft sequence of tokens. The draft tokens are scored by a second, e.g., larger, trained machine learning model and part of the draft sequence is accepted for use in the sequence defining the digital object, up until a point where a draft token is rejected. The second trained machine learning model can then be used when selecting the next token, i.e., a token to use instead of the rejected draft token. Since generating the draft tokens can be quicker than generating a token using the second, e.g., larger, trained machine learning model, even though some draft tokens are rejected, on average this can reduce latency, particularly where the scoring is performed in parallel.

For example in some implementations the trained machine learning model is a first, draft trained machine learning model and generating each token in the sequence defining the digital object involves processing preceding tokens in the sequence using the first, draft trained machine learning model to determine the initial probability distribution.

Selecting the current token in the sequence (defining the digital object) in accordance with the modified probability distribution over the possible tokens can then involve selecting a current token of a draft sequence of one or more tokens in accordance with the modified probability distribution.

The one or more preceding tokens in the sequence (defining the digital object) can be processed using a second trained machine learning model to determine a second model probability distribution. The second trained machine learning model can be larger than the first, i.e., it can have more learned parameters, e.g., weights.

A determination of whether to accept the selected current token of the draft sequence as the current token in the sequence of tokens defining the digital object can be made.

In some implementations this is done by comparing a probability of the selected current token according to the modified probability distribution and a probability of the selected current token according to a modified second model probability distribution that is a modified, i.e., watermarked version of the second model probability distribution. For example the modified second model probability distribution can obtained by applying to a representation of, or to samples from, a probability distribution associated with each of a plurality of second model watermarking stages, a modification based on a respective second model pseudorandom function that is a function of one or more of the preceding tokens in the sequence and a supposed (possible) current token.

In some implementations this is done by comparing a probability of the selected current token according to the initial probability distribution and a probability of the selected current token according to the second model probability distribution.

The selected current token of the draft sequence can then be used as the current token in the sequence of tokens defining the digital object when the selected current token of the draft sequence is accepted. When the selected current token of the draft sequence is rejected the current token in the sequence of tokens defining the digital object can be selected using the second trained machine learning model.

The above-described techniques involving a draft sequence and draft tokens are not limited in their application to the particular watermarking technique described and can be applied to any watermarking technique that involves modifying a probability distribution from which tokens for a sequence of tokens are selected.

In another aspect there is described a computer-implemented method of generating a watermarked digital object defined by a sequence of tokens, by extending an initial sequence of tokens.

The method involves processing the initial sequence of tokens using a first, draft trained machine learning model to autoregressively generate a draft sequence of tokens. This can involve, at each of a series of time steps processing the initial sequence of tokens and previously generated tokens of the draft sequence to generate a draft probability distribution, modifying the draft probability distribution to generate a watermarked draft probability distribution, and sampling a current draft token from the watermarked draft probability distribution.

In general the watermarked draft probability distribution is a probability distribution that can be detected with a watermark detecting process. For example the draft probability distribution may have been modified using one or more keys to obtain the watermarked draft probability distribution; and a sequence of tokens may be processed using the one or more keys to determine a value representing a probability that the sequence was generated using the watermarked draft probability distribution.

Each of the tokens of the draft sequence can be evaluated using one or more instances of a second trained machine learning model. This can involve processing the initial sequence of tokens and the draft sequence of tokens up to the evaluated token using the second trained machine learning model to determine either a second model probability distribution or a watermarked second model probability distribution that is a watermarked version of the second model probability distribution. The watermarked second model probability distribution is a probability distribution that can be detected with a watermark detecting process, e.g., using one or more keys used to modify the second model probability distribution to obtain the watermarked second model probability distribution.

For each successive token of the draft sequence a decision, in implementations a stochastic decision, can be made whether to accept or reject the token of the draft sequence.

In some implementations this can be done by comparing a probability of the token according to the watermarked draft probability distribution for the initial sequence of tokens and the draft sequence of tokens up to the preceding token, and a probability of the token according to the watermarked second model probability distribution for the initial sequence of tokens and the draft sequence of tokens up to the preceding token. The preceding token is the token preceding the token for which the probabilities are compared.

In some implementations this can be done by comparing a probability of the token according to the draft probability distribution for the initial sequence of tokens and the draft sequence of tokens up to the preceding token, and a probability of the token according to the second model probability distribution for the initial sequence of tokens and the draft sequence of tokens up to the preceding token.

The series of successively accepted tokens of the draft sequence is used for the sequence of tokens defining the watermarked digital object, up to where a token of the draft sequence is rejected. Then, instead of using the rejected token, the next token is selected for the sequence of tokens defining the watermarked digital object using the second trained machine learning model.

Once the sequence has been extended as described above, typically using one or more draft tokens, the extended sequence can be used as the initial sequence of tokens for a subsequent iteration.

To decode (detect) a watermark generated as described above a watermarking score can be determined by applying the same pseudorandom functions to sequences of n+I tokens in a sequence of tokens to be analyzed and combining the results. A value of the watermarking score can then be used to determine whether or not the sequence of tokens is likely to be watermarked.

In another aspect there is described a computer-implemented method of detecting watermarking of a digital object, in particular a digital object that has been watermarked as described above, where the digital object is defined by a sequence of tokens.

The method involves determining a watermarking score for the digital object, comparing the watermarking score with a threshold to detect watermarking of the digital object.

Determining the watermarking score for the digital object comprises determining a set of sub-sequences of the sequence of tokens, each sub-sequence starting at a different respective token of the sequence of tokens. For each of a predetermined number of watermarking stages the method determines a value of a pseudorandom function associated with the watermarking stage for each subsequence of the set of sub-sequences. The method sums score contributions based on the determined values of the pseudorandom function over i) each of the predetermined number of watermarking stages, and ii) each subsequence of the set of sub-sequences, to determine the watermarking score.

In implementations the pseudorandom function associated with each watermarking stage is a function that was used to modify a probability distribution over possible tokens selected from when generating tokens of the sequence of tokens so as to bias the sequence to (on average) have an increased watermarking score when determined as described above.

In a further aspect there is described a computer-implemented method of detecting watermarking of a digital object, where the digital object is defined by a sequence of tokens.

The method involves determining a first probability of each of one or more keys used to generate the watermarked draft probability distribution assuming the sequence of tokens is watermarked. Implementations of the method also use a second probability of each of one or more keys used to generate the watermarked second model probability distribution assuming the sequence of tokens is watermarked. The first probability and the second probability can then be combined to determine a watermarking score for the digital object. The watermarking score can be compared with a threshold, e.g., dependent on a prior probability that the sequence of tokens is watermarked, to detect watermarking of the digital object.

Particular embodiments of the subject matter described in this specification can be implemented so as to realize one or more of the following advantages.

There is a need to be able to distinguish machine-generated content from human-generated content, particularly where the machine-generated content might be misleadingly represented as human generated. As another example, human-generated content might be represented as machine-generated; or content generated by one machine might be misleadingly represented as generated by a different machine, e.g., undesirable content could be represented as having originated from a trustworthy source. Watermarking is a general technique that can be used for distinguishing between content to address such problems, but can have drawbacks.

Some implementations of the described techniques enable robust and detectable watermarking to be added to a digital object with relatively low computational overhead (depending on the number of watermarking stages applied). The watermarking is robust in the sense that it is relatively unaffected by small modifications to the content, e.g., to the text in a text object. The watermarked content can be distinguished from unwatermarked content with a relatively high degree of confidence, and the watermarking process results in little degradation of the quality of the generated content.

In broad terms implementations of the technique preferentially pick watermark-consistent continuation tokens, without significantly changing an overall token probability under the machine learning model. More specifically, some implementations of the described techniques bias the token distribution towards a secret distribution determined by the pseudorandom function associated with each watermarking stage, whilst preserving the underlying machine learning model token distribution in expectation over values of the pseudorandom function.

Implementations of the described techniques can be wrapped around any existing (autoregressive) machine learning model and are not dependent on details of the model, which can be treated as a black box. This facilitates their implementation in a wide range of settings, and retrofitting to an existing system.

Some implementations of the described techniques can be shown to be non-distortionary, i.e., on averaging over a uniformly distributed source of randomness the modified probability distribution (watermarked distribution) is the same as the initial probability distribution, thus preserving quality. Where there is distortion (e.g., in tournament rounds with more than two tokens each) the watermarking process can add distortion but outperforms other distortionary techniques, giving better detection performance for a similar impact on quality. Empirically, the watermarking process does not affect various automatically-measurable properties of the generated text such as its length, diversity, and perplexity, and in a human preference test watermarked sequence were rated for quality as highly as unwatermarked sequences. Some implementations of the described techniques can be shown to be N-shot undetectable, i.e., with certain conditions (and with repeated context masking as described later) the probability of generating N responses is, in expectation over key values, the same as from the unwatermarked model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE FIGURES

FIG. 1 shows an example of a generative machine learning system with watermarking.

FIG. 2 illustrates operation of a first example process for watermarking a digital object.

FIG. 3 is a flow diagram of the first example process for watermarking a digital object.

FIG. 4 is a flow diagram of a second example process for watermarking a digital object.

FIG. 5 illustrates operation of the second example process for watermarking a digital object.

FIG. 6 is a flow diagram of a first example process for detecting watermarking of a digital object.

FIG. 7 shows example watermarking score distributions for unwatermarked and watermarked digital objects.

FIG. 8 illustrates changes in token log-probability due to watermarking.

FIG. 9 illustrates detectability of watermarks according to an example of the described process.

FIG. 10 is a flow diagram of a third example process for watermarking a digital object.

FIG. 11 is a flow diagram of a further example process for detecting watermarking of a digital object

Like reference numbers and designations in the various drawings indicate like elements.

### DETAILED DESCRIPTION

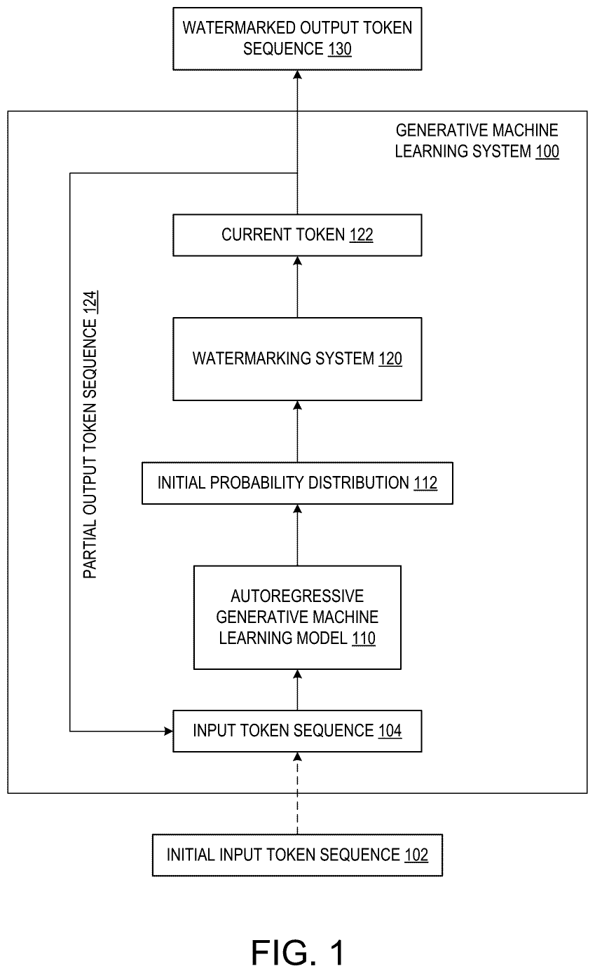

FIG. 1 shows an example of a generative machine learning system 100 including a watermarking system 120 configured to perform watermarking as described herein. The generative machine learning system 100 may be implemented as one or more computer programs on one or more computers in one or more locations.

The system 100 includes an autoregressive generative machine learning model 110, e.g., an autoregressive generative neural network, that has been trained to autoregressively generate, for each of a plurality of token generation steps, an output that defines a probability distribution over possible current output tokens at the token generation step, conditioned on output tokens that have been generated, more particularly sampled, at preceding token generation steps. The system 100 generates a watermarked output token sequence 130 defining a digital object.

In more detail, the autoregressive generative machine learning model 110 is configured to process an input token sequence 104 to define an initial probability distribution 112 over possible tokens for the current token, e.g., as a likelihood for each possible token of a set, or vocabulary, of possible tokens for the current token defined by a respective set of token scores. The initial probability distribution can be defined in a variety of ways. As one example, the initial probability distribution can be a categorical probability distribution defined by a set of token scores generated by the autoregressive generative machine learning model 110. As another example, the initial probability distribution can be a continuous probability distribution parameterized by an output of the autoregressive generative machine learning model 110, e.g., for selecting tokens representing discretized values of a continuous variable such as pixel intensity.

The initial probability distribution 112, e.g., the set of token scores, is used for selecting a current token 122 in a sequence of tokens being generated by the system. Once the current token has been selected it is added to a partial output token sequence 124, and the partial output token sequence is provided as the input token sequence 104 for selecting a next current token.

At the start of the token generation process the input token sequence 104 can be a null (empty) sequence, or it may comprise an initial input token sequence 102, such as a prompt or other input sequence. The autoregressive generation of tokens may continue until a termination criterion is reached, e.g., a specified length of sequence, or selection of an end-of-sequence token as the current token 122. The partial output token sequence 124 then provides the watermarked output token sequence 130. The system thus generates a watermarked digital object, i.e., the watermarked output token sequence 130. In general the digital object may be any type of object e.g., a text, image, audio, or multimedia object.

The initial probability distribution 112, e.g., the set of token scores, is used by the watermarking system 120, as described in more detail below, to select the current token 122 in accordance with a modified probability distribution over the possible tokens for the current token i.e., over the possible tokens that the current token can be.

In some implementations the autoregressive generative machine learning model 110 comprises a natural language generation model, in particular a natural language generation neural network. As an example, the natural language generation neural network can be a transformer-based neural network model, characterized by having a succession of self-attention neural network layers. In some of these implementations the model can include a transformer-based encoder to encode the input token sequence 104; in some other implementations such an encoder is not used. As some illustrative examples, the natural language generation neural network can be a model such as Sparrow (Glaese et al., arXiv:2209.14375), Chinchilla (Hoffmann et al., arXiv:22203.15556), PaLM (Chowdhery et al., arXiv:2204.02311), LaMDA or Bard (Thoppilan et al., arXiv:2201.08239). The natural language generation model can be any model that generates natural language, e.g., a dialog model for a conversation agent, or a question-answering model, or a neural machine translation model.

The autoregressive generative machine learning model 110 may be a multimodal model. For example, it may accept a multimodal input or generate a multimodal output, e.g., including natural language.

In implementations the natural language generation model comprises a sequence-to-sequence model that receives an input sequence of natural language tokens and generates an output sequence of natural language tokens. Typically a natural language token defines a word or wordpiece (e.g., a word segment or morpheme, or a logogram or syllabogram), but it may also define a letter, or multiple words. The tokens may include tokens representing punctuation. In general the output sequence of natural language tokens is generated a token at a time, selecting the tokens from a vocabulary of possible natural language tokens.

In implementations the input sequence of natural language tokens is converted into a sequence of input embeddings that is processed by the natural language generation neural network, e.g., a transformer-based neural network, to generate the initial probability distribution over possible tokens in the vocabulary, e.g., using a softmax output layer. Where multimodal input data is processed an input image may also be represented as a sequence of embeddings, which may be combined, e.g., interleaved, with text embeddings of the natural language tokens. As used herein an embedding may comprise a vector of numeric values.

The initial input token sequence 102 can be empty or it can include, e.g., text to be translated from a natural language of the input token sequence into a different natural language for the (watermarked) output token sequence, or a natural language prompt or question to guide the (watermarked) output token sequence, or part of a preceding dialog with an agent including the natural language generation neural network.

In some implementations the autoregressive generative machine learning model 110 comprises a computer language generation model, in particular a computer language generation neural network, for automatic code generation. Then the initial input token sequence 102 can be empty or it can include, e.g., text describing or illustrating a task to be performed by a computer. The (watermarked) output token sequence can comprise tokens from a vocabulary for expressing commands to be compiled or executed by a computer system, e.g., tokens representing instructions in a computer programming or markup language, or for controlling an application program.

As another example, the autoregressive generative machine learning model 110 may comprise an image generation neural network for generating a still or moving image (video), e.g., a transformer-based model. In these implementations the tokens, i.e., image tokens, may represent image or video features, and a sequence of such tokens may represent an image or video. For example, an image may be represented as a sequence of tokens representing regions of interest in the image encoded using an encoder neural network; or the tokens may encode color or intensity values of pixels of an image. In some implementations such a model may be conditioned on a text input to generate a still or moving image that is a visualization of the text input.

As a further example, the autoregressive generative machine learning model 110 may comprise an audio generation neural network, e.g., a speech synthesis neural network. In these implementations the tokens may represent values, regions, or features of an audio waveform. For example, the tokens, i.e., audio tokens, may characterize a waveform of the audio in the time domain, or in the time-frequency domain, or may characterize phonemes. The audio generation neural network may be conditioned on a text input to convert the text into audio tokens representing an audio waveform of speech corresponding to the text.

As previously described, the current token 122 is selected in accordance with a modified probability distribution over the possible tokens, using the watermarking system 120.

In some implementations this is done by selecting a plurality of samples from the initial probability distribution. In implementations the samples are sample tokens, referred to herein as tournament tokens. Then, at each of a succession of watermarking stages, the watermarking system 120 selects from amongst these until, at the last watermarking stage, a sample token is selected which is treated as the current token 122.

The selecting performed at a watermarking stage is based on a respective pseudorandom function for the watermarking stage. For example, at a watermarking stage a value of the respective pseudorandom function can be determined for each selected tournament token, and then the values compared in a tournament to select a subset of the tournament tokens for the next watermarking stage. In some implementations the watermarking process continues until only a single tournament token remains, which is used as the current token 122. The pseudorandom function can provide a discrete, e.g., binary, or continuous value output.

The aforementioned process of selecting modifies a probability distribution over the possible tokens at each watermarking stage, from the initial probability distribution to, at the end, the modified probability distribution.

In implementations the pseudorandom function is a function of one or more of, e.g., a predetermined number of, the preceding tokens in the sequence, and of a supposed current token. In this example, the supposed current token is the tournament token. In some implementations the pseudorandom function can be a function of all the preceding tokens in the sequence, e.g., where the pseudorandom function takes a variable length input.

In some other implementations the current token 122 is selected in accordance with a modified probability distribution over the possible tokens by modifying an explicit representation of the initial probability distribution 112, e.g., the set of token scores. In these implementations the representation of the initial probability distribution, e.g., the set of token scores, can be successively modified at each watermarking stage using the respective pseudorandom function, to define successive intermediate probability distributions. The modified probability distribution is obtained after the final watermarking stage, e.g., as a modified set of token scores. The current token 122 can then be sampled from the modified probability distribution.

In some implementations of both these approaches the probability distribution associated with a watermarking stage is unchanged when averaged over values of the respective pseudorandom function, that is the token distribution defined by the initial probability distribution is preserved in expectation over values of the pseudorandom function. Nonetheless the initial probability distribution is modified to bias it towards one which can be identified in the output token sequence 130, i.e., the output token sequence 130 is watermarked. More watermarking stages can result in greater bias up to a certain depth, and greater detectability of the watermark, though at the expense of additional computing resources.

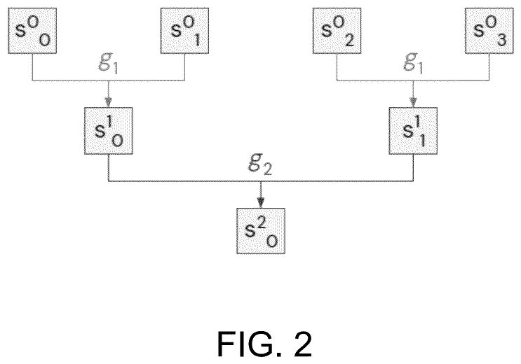

FIG. 2 illustrates the operation of a first example process for watermarking a digital object defined by a sequence of tokens. More particularly FIG. 2 illustrates, schematically, the operation of a first process for selecting the current token 122 at a token generation step.

In this example, in an initial, watermarking stage, four tournament tokens, s₀⁰, s₁⁰, s₂⁰, s₃⁰, are sampled from the initial probability distribution 112, e.g., as defined by the set of token scores. This initial probability distribution may be denoted p(·|x_{<t}), where x_{<t}=(x₁, . . . , xₜ₋₁) denotes the preceding, already-generated tokens, i.e., the partial output token sequence 124. A value, g₁, of the pseudorandom function for the initial watermarking stage can be determined for each of these tournament tokens as described further below.

Two of these tournament tokens are selected, based on the value of the pseudorandom function for each of the tournament tokens, to provide the tournament tokens for the next watermarking stage, in FIG. 2 denoted s₀¹, s₁¹. As an example, this can involve making comparisons between pairs of tournament tokens, e.g., picking the tournament token with the largest value of the pseudorandom function at each comparison. A random selection can be made if the values are the same.

At the next watermarking stage a value, g₂, of the pseudorandom function for this watermarking stage is determined for each of tournament tokens, s₀¹, s₁¹, and one of these is selected as the tournament winner, in FIG. 2 s₀², and is used as the current token 122, xₜ. This selection process results in xₜ being selected from the modified probability distribution. Generating successive tokens in this way results in a watermarked digital object defined by the output token sequence 130.

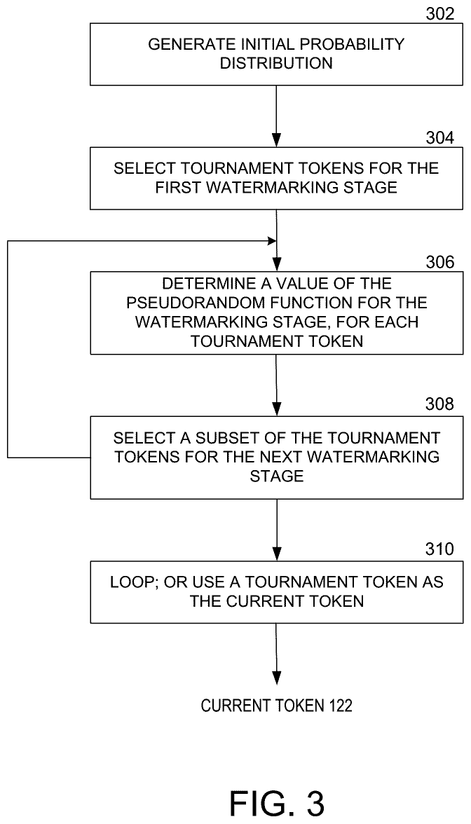

FIG. 3 is a flow diagram of a first example process for watermarking a digital object defined by a sequence of tokens that uses such an approach. The process of FIG. 3 can be performed by a system of one or more computers located in one or more locations, e.g., by the generative machine learning system 100 of FIG. 1. The watermarking process involves watermarking the digital object as it is generated, by generating the watermarked output token sequence 130. The process of FIG. 3 can be performed at each token generation step.

At step 302 the autoregressive generative machine learning model 110 processes the preceding tokens in the output sequence, that have already been generated, x_{<t}, i.e., the partial output token sequence 124, to generate the initial probability distribution 112, p(·|x_{<t}), The initial probability distribution 112 can be represented as a set of token scores, as previously described, or in some other way.

The process then selects a plurality of tournament tokens for the first watermarking stage from the initial probability distribution 112 (step 304). In implementations repeated selection of the same token is allowed. For m watermarking stages 2^{m} tournament tokens can be selected initially.

A value of the pseudorandom function for the watermarking stage is then determined for each of the tournament tokens (step 306). Any suitable pseudorandom function may be used. The pseudorandom functions used at the different watermarking stages may be, but are not necessarily, different to one another.

In some implementations the pseudorandom function for a watermarking stage is a function of a supposed current token, xₜ, and one or more of the preceding tokens, x_{<t}, e.g., a function of the supposed current token, xₜ, and a property of one or more of the preceding tokens X_{<t}. When determining the value of the pseudorandom function for a tournament token the supposed current token, xₜ, can be the tournament token. As examples, the pseudorandom function can have a value in the range [0,1]; or the output can be either 0 or 1.

In some implementations the pseudorandom function may comprise a cryptographic hash function, i.e., the value of the pseudorandom function may be determined from a cryptographic hash of the supposed current token and the one or more preceding tokens. In some implementations the pseudorandom function is based on a cryptographic key (a “watermarking key”), e.g., as a function of the supposed current token, the one or more of the preceding tokens, and the cryptographic key. For example, the value of the pseudorandom function may be determined by encrypting the tokens, e.g., using a cryptographic algorithm, or by determining a MAC (message authentication code) value from the supposed current token and the one or more of the preceding tokens.

A subset of the tournament tokens is then selected for the next watermarking stage using the determined values of the pseudorandom function (step 308), e.g., selecting half of the tournament tokens by pairwise comparison of the values.

The process then loops back to iteratively apply the next watermarking stage or, if the last watermarking stage has been reached, e.g., if the previous step selected a single tournament token, the or one of the tournament tokens from that stage is used as the current token 122 (step 310).

The process of FIG. 3 is then performed again, to generate the next current token for the watermarked output token sequence 130 at the next token generation step until, e.g., an end of sequence token is selected as the current token 122.

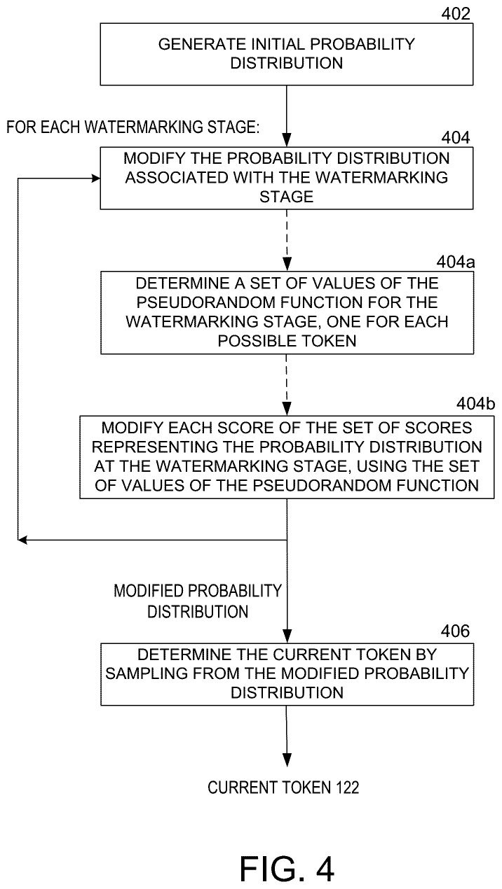

FIG. 4 is a flow diagram of a second example process for watermarking a digital object defined by a sequence of tokens. The process of FIG. 4 can be performed by a system of one or more computers located in one or more locations, e.g., by the generative machine learning system 100 of FIG. 1. Again the watermarking process involves watermarking the digital object as it is generated, by generating the watermarked output token sequence 130. The process of FIG. 4 can be performed at each token generation step.

At step 402 the autoregressive generative machine learning model 110 processes the preceding tokens in the output sequence, x_{<t}, i.e., the partial output token sequence 124, to generate the initial probability distribution 112, p(·|x_{<t}). The initial probability distribution 112 may be represented, e.g., as a set of token scores as previously described or in some other way.

The process then modifies the representation of the probability distribution associated with each watermarking stage using the respective pseudorandom function for the watermarking stage to determine, at the last watermarking stage, the modified probability distribution (step 404).

In the example process of FIG. 4 modifying the representation of the probability distribution involves determining a set of pseudorandom function values, one for each of the possible tokens for the current token in the sequence, e.g., one for each of the possible tokens in the vocabulary of tokens (step 404a). The pseudorandom functions for the watermarking stages may be as previously described.

In some implementations the pseudorandom function for a watermarking stage is a function of a supposed current token, xₜ, and of one or more of the preceding tokens, x_{<t}. Each of the possible tokens in the vocabulary of tokens can be used as the supposed token, to determine each value in the set of pseudorandom function values. For example, for the lth watermarking stage the value of the pseudorandom function for a supposed current token, xₜ, that is one of the possible tokens in the vocabulary may be determined as gₗ(xₜ) (where the dependence on the preceding token(s) has been omitted for clarity).

The probability distribution at the watermarking stage is then modified. In implementations where the probability distribution is represented as a set of scores, each score of the set of scores is modified using a corresponding value in the set of pseudorandom function values (step 404b), i.e., the score for a possible token is modified using the value of the pseudorandom function with that token as the supposed current token. The process then loops back to modify the probability distribution associated with the next watermarking stage. This iteratively determines an intermediate modified probability distribution for each of the intermediate watermarking stages, until the modified probability distribution is determined at the last watermarking stage.

One way in which a score for a token can be modified is by increasing the score using a scaling factor that depends on the corresponding value in the set of pseudorandom function values. The scaling factor may also include a normalizing term, β. For example, the scaling factor can be determined as [1+gₗ(xₜ)−β]. The normalizing term β may be determined as Σ\tilde{p}(xₜ|x_{<t})gₗ(xₜ), where \tilde{p}(xₜ|x_{<t}) is the intermediate modified probability distribution for the watermarking stage and the sum is over possible tokens in the vocabulary of tokens. The intermediate modified probability distribution for watermarking stage l can be determined as \tilde{p}ₗ(xₜ|x_{<t})=\tilde{p}ₗ₋₁(xₜ|x_{<t})[1+gₗ(xₜ)−β], where \tilde{p}₁(xₜ|x_{<t})=p_{AM}(xₜ|x_{<t})[1+gₗ(xₜ)−β] and p_{AM}(xₜ|x_{<t}) is the initial probability distribution from the autoregressive generative machine learning model 110. The modified probability distribution determined at the last, mth, watermarking stage is \tilde{p}ₘ(xₜ|x_{<t}).

The current token 122 is then determined by sampling from the modified probability distribution, \tilde{p}ₘ(xₜ|x_{<t}), represented in this example process by a modified set of scores (step 406).

The process of FIG. 4 is then performed again to generate the next current token for the watermarked output token sequence 130 at the next token generation step until, e.g., an end of sequence token is selected as the current token 122.

Where values of the pseudorandom function are {0,1 } the processes of FIGS. 3 and 4 are equivalent.

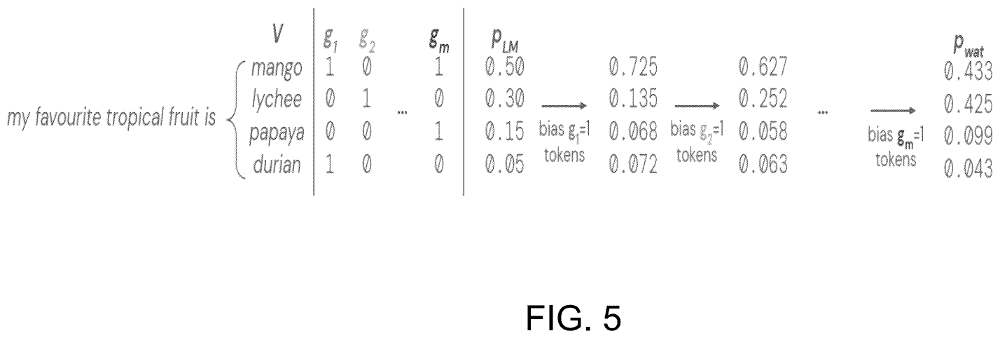

FIG. 5 illustrates operation of the second example process for watermarking a digital object. In the toy example of FIG. 5 the initial probability distribution is denoted p_{LM} and the possible tokens of the vocabulary of tokens, V, are “mango”, “lychee”, “papaya”, and “durian”. Values of the pseudorandom function for the first watermarking stage, g₁ for each possible token 1, 0, 0, 1, modify p_{LM} from an initial set of scores 0.50, 0.30, 0.15, 0.05 to a modified set of scores 0.725, 0.135, 0.068, 0.072 representing an intermediate (normalized) probability distribution, \tilde{p}₁. These are obtained by applying the scaling factor [1+gₗ(xₜ)−β] with normalization β=0.55. The probability scores for each successive watermarking stage is modified in a corresponding manner. The modified probability distribution is denoted p_{wat}; in expectation over the pseudorandom functions g, p_{wat}=p_{LM}.

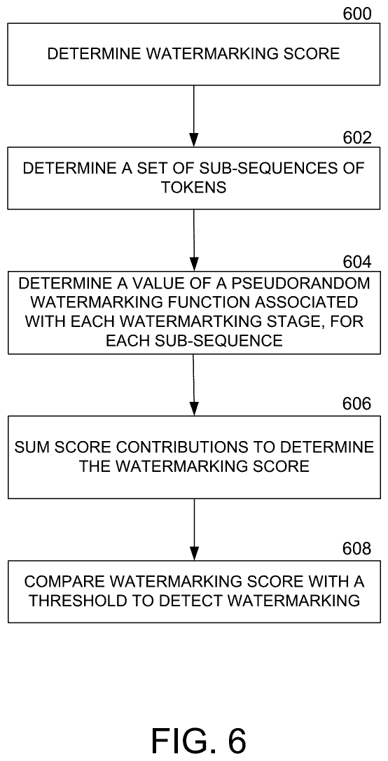

FIG. 6 is a flow diagram of a first example process for detecting watermarking of a digital object defined by a sequence of tokens. The process of FIG. 6 can be performed by a system of one or more computers located in one or more locations.

The watermark can be detected using the same pseudorandom function(s) that were used to create it. More particularly this can be done by determining a watermarking score using the pseudorandom function(s) (step 600). The watermarking score obtained by processing the outputs from the pseudorandom function(s) can then be compared with a threshold to detect watermarking of the digital object (step 608). The threshold can be determined empirically, e.g., based on an ROC (receiver operating characteristic) curve, e.g., based on the AUC (area under the ROC), for a particular true or false positive rate, or precision.

In implementations determining the watermarking score involves determining a set of sub-sequences of the sequence of tokens, each sub-sequence starting at a different respective token of the sequence of tokens (step 602). Then a value of a pseudorandom (watermarking) function associated with each watermarking stage is determined for each subsequence (step 604). Score contributions based on the determined values are then summed to determine the watermarking score (step 606).

In more detail, the processing of the outputs from the pseudorandom function can be done by taking an average across the layers and the length of the sequence, or by taking a weighted average in which the contributions from one or more of the deeper (earlier) layers are given less weight than those from one or more of the shallower (later) layers.

For a digital object defined by a sequence of tokens the watermarking score can be determined by summing score contributions dependent on the pseudorandom functions. The sum is taken over i) each of the predetermined number of watermarking stages, and ii) each subsequence of a set of sub-sequences of the tokens, where each sub-sequence is used for determining a value of the pseudorandom function for the watermarking stage. Each score contribution can be, but is not necessarily, the value of the pseudorandom function for a sub-sequence; in general it is determined based on the value of the pseudorandom function for a sub-sequence.

In general each sub-sequence is a subsequence from the sequence of tokens. In some implementations, but not necessarily, each sub-sequence comprises consecutive tokens of the sequence of tokens, each sub-sequence starting at a different respective token of the sequence of tokens. One way of determining the set of sub-sequences of the tokens is to base each subsequence on a different respective base token of the sequence of tokens making up the digital object. The different respective base tokens may define successive tokens of the sequence of tokens making up the digital object. Each subsequence may comprise a predetermined number of tokens of the sequence of tokens, e.g., tokens up to, or from, this base token; or the subsequence may comprise all the tokens up to this base token. In particular, where the watermark was generated by determining the value of a respective pseudorandom function for the watermarking stage as function of a supposed current token and of one or more of the preceding tokens in the sequence, the subsequence may comprise the same total number of tokens as were input to the pseudorandom function when the watermark was generated.

In some implementations the score contributions for each particular watermarking stage are summed to determine a respective watermarking stage sum, by summing the score contributions based on the determined values of the pseudorandom function associated with the particular watermarking stage. Then the watermarking stage sums are summed to determine the watermarking score.

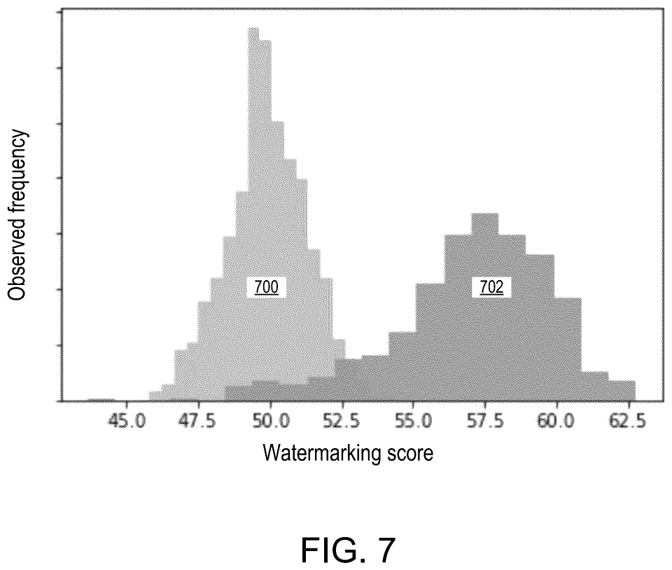

FIG. 7 shows example distributions of watermarking scores for unwatermarked digital objects 700 and for watermarked digital objects 702, with watermarking score on the x-axis and observed frequency on the y-axis. The distributions are well-separated indicating effective watermarking.

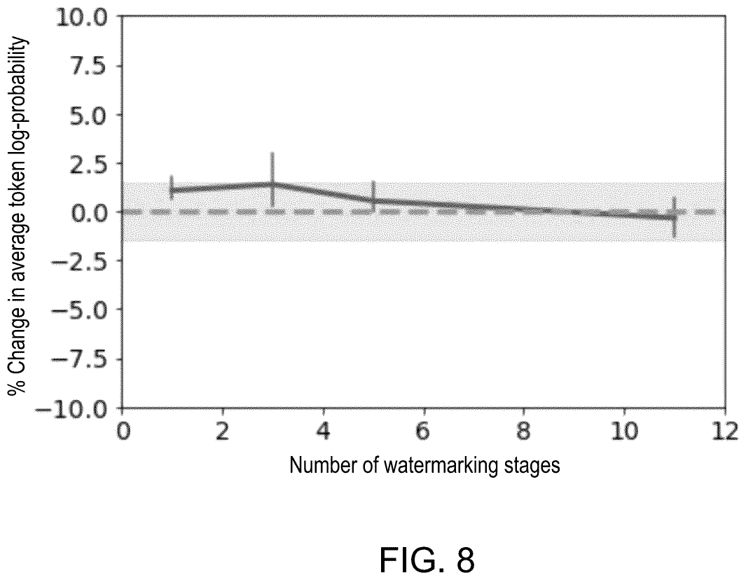

FIG. 8 shows, as the solid line, a percentage change, relative to an unwatermarked model, in average watermarked token log-probability on the y-axis, for different numbers of watermarking stages on the x-axis. FIG. 8 suggests that the watermarking process has little or no overall deleterious effect.

### Example Implementations

There now follow further details of a few example implementations.

Consider sampling each current token, sₜ, in a token vocabulary, V, from a language model distribution p_{LM}(·|x_{<t}) where x_{<t} denotes previously sampled tokens. A number, k, of supposed current tokens could be sampled, choosing as the current token the token that scores highest under a pseudorandom function g(sₜ|x_{<t}). The average value of g(·) evaluated for watermarked text would be expected to be higher than for unwatermarked text, allowing the watermark to be detected. However in practice the underlying diversity is not sufficient for a strong watermark.

As described herein, m layers of watermarking are used, each with a respective pseudorandom function g₁, g₂, . . . , gₘ. In some implementations k^{m} tokens are sampled and randomly grouped into k^{m-1} sets of k tokens each. Within each set the highest scoring token under g₁ is chosen and the others eliminated, and the remaining k^{m-1} tokens are randomly split into k^{m-2} and evaluated under g₂, and so forth (randomly breaking ties). This biases the token generation process towards choosing tokens that score higher under each of the pseudorandom functions g₁, g₂, . . . , gₘ. Watermarked text can then be detected, e.g., by evaluating:

$$watermarking\_score ( x ) = \frac{1}{mL} {\sum }_{t = 1}^{L} {\sum }_{l = 1}^{m} {g}_{l} ( {x}_{t} , {x}_{< t , n} )$$

where each pseudorandom function is a function of n preceding tokens, x_{<t,n} and the current token. Sequences with a higher score can be attributed to watermarked generation. Optionally each watermarking layer may be given a weight αₗ that multiplies gₗ(xₜ, x_{<t,n}). This provides multiple observables per token, resulting in reduced variance in the watermarking score.

This illustrates one way of determining a watermarking score for detecting a watermark, but there are alternative scoring functions that can be used, e.g., to take account of each watermarking layer using up some of the available diversity/entropy to bias the generation towards a higher score under gₗ(·).

An example process for generating a current token using multi-layer tournament sampling is given below:

Require: Input text x_{<t}, LLM distribution p_{LM}, keys k₁, . . . , kₘ, context
length n, pseudorandom function g, number of samples N.

| | |
|---|---|
| 1: | Draw N^{m} independent samples s₀⁰, s₁⁰, . . . , s₂_{^{m}}₋₁⁰ ~ p_{LM}(\|x_{<t}) (may |
| | contain repeats). |
| 2: | for 1 ≤ [symbol] ≤ m do |
| 3: | for ≤ j ≤ 2^{m-} [symbol] − 1 do |
| 4: 5: | $if g ( {s}_{2 j}^{ℓ - 1} \vert {x}_{< t , n} . {k}_{ℓ} ) = g ( {s}_{2 j + 1}^{ℓ - 1} \vert {x}_{< t , n} , {k}_{ℓ} ) then \\ Sample {s}_{j}^{ℓ} ∼ 𝒰 ( \{ {s}_{2 j}^{ℓ - 1} , {s}_{2 j + 1}^{ℓ - 1} \} )$ |
| 6: | else |
| 7: | |
| 8: | end if |
| 9: | end for |
| 10: | end for |
| 11: | return xₜ := s₀^{m} |

In this example the pseudorandom function for each watermarking stage is based on (depends on) a different respective key k₁, k₂, . . . , kₘ.

A probability distribution for the winning token can be determined directly rather than by running a tournament; this can be computationally beneficial. For example, the probability distribution of the winning token, p_{wm}(·|x_{<t,n}, k) for a layer with key k is given by:

$${p}_{wm} ( {x}_{t} \vert {x}_{< t} , k ) = {p}_{LM} ( {x}_{t} \vert {x}_{< t} ) [ 1 + g ( {x}_{t} \vert {x}_{< t , n} , k ) - {\sum }_{{x}_{t}^{′} ∈ V} g ( {x}_{t}^{′} \vert {x}_{< t , n} , k ) {p}_{LM} ( {x}_{t}^{′} \vert {x}_{< t} ) ]$$

This can be used to compute a representation of a probability distribution associated with the first watermarking stage, p_{wm}(·|x_{<t,n}, k₁). Then a representation of a probability distribution for each successive watermarking stage can be determined according to:

$${p}_{wm} ( {x}_{t} \vert {x}_{< t} , {k}_{1 : ℓ} ) = {p}_{LM} ( {x}_{t} \vert {x}_{< t} , {k}_{1 : ℓ - 1} ) [ 1 + g ( {x}_{t} \vert {x}_{< t , n} , {k}_{ℓ} ) - {\sum }_{{x}_{t}^{′} ∈ V} g ( {x}_{t}^{′} \vert {x}_{< t , n} , {k}_{ℓ} ) {p}_{wm} ( {x}_{t}^{′} \vert {x}_{< t} . {k}_{1 : ℓ - 1} ) ]$$

In implementations the watermark is not applied for the first n steps of token generation as the context may be ill-defined or may depend on a prompt that is not available during watermark detection. These steps can then also be omitted when determining a watermarking score, e.g., as described above.

In some implementations if a particular n-gram context has been seen earlier in the generated sequence, i.e., if a particular sequence of n tokens is repeated, the watermark is not applied when selecting the current token for step t, as this can introduce a repeated bias that can affect the quality of the generated sequence. This approach can be extended over the generation of multiple sequences. These time steps can then also be omitted when determining a watermarking score, e.g., as described above.

In one approach the watermarking score can be modelled as a binomial distribution B(Lm, 0.5) and a p-value for classifying a sequence as watermarked or unwatermarked can be determined as:

$$p - value = 1 - {CDF}_{B ( Lm , 0.5 )} ( watermarking\_score ( x ) - 1 )$$

where CDF is a cumulative distribution function, and where a watermark can be detected by comparing the p-value with a p-value threshold.

In another approach the watermarking score can be determined using a Bayesian model that is based on a prior belief, P(w), about the likelihood of the sequence being watermarked, and on the observed g-values. The prior belief can be used, e.g., to take account of prior knowledge of the likelihood that a sequence is watermarked as opposed to human-generated; and the Bayesian approach considers how g-values are distributed under hypotheses that the text is watermarked, P(g|w), and that the text is not, watermarked, P(g|¬w). For example in some implementations the likelihood ratio can be determined as:

$$\frac{P ( g \vert w )}{P ( g \vert ¬ w )} = {\prod }_{i}^{t} {\prod }_{j}^{m} [ {P}_{{ψ}_{j}} + ( {g}_{ij} + 0.5 ) ( 1 - {P}_{{ψ}_{j}} ) ]$$

where t is the number of tokens in the sequence and m is the number of watermarking layers, P(g|¬w)=0.5^{tm} (where P(gᵢⱼ|¬w)=0.5), and P_{ψj} is the probability of a latent variable ψⱼ∈{1,2} that refers to the number of unique candidate tokens in the tournament match at layer j (this can be 1 if there is a tie). A value for P_{ψj} can be learned based on example (training) sequences. For example P_{ψj=1} can be modelled as P_{ψj=1}=σ(βⱼ+Σₗ₌₁^{j-1}δⱼₗgᵢₗ) where σ(·) is the sigmoid function, δ is the delta function, βⱼ is a (learnable) bias parameter for layer j, and the sum is over the layers that precede layer j. If the likelihood ratio is greater than 1 the sequence can be identified as watermarked.

A more computational favorable expression of this is:

$$log ( \frac{P ( g \vert w )}{P ( g \vert ¬ w )} ) = {\sum }_{i}^{t} {\sum }_{j}^{m} log [ {P}_{{ψ}_{j}} + ( {g}_{ij} + 0.5 ) ( 1 - {P}_{{ψ}_{j}} ) ] + log ( P ( w ) ) - log ( 1 - P ( w ) )$$

and an example algorithm for determining using such a Bayesian model is:

Require: pseudorandom function values g, set of functions f_{ψ}_{ⱼ} to get

| | learnable latents {P_{ψ}_{ⱼ}}_{jϵ1, ...,d}, prior P(w). |
|---|---|
| 1: | |
| 2: | for 0 ≤ i ≤ t do |
| 3: | for 1 ≤ j ≤ m do |
| 4: | P_{ψ}_{ⱼ} := f_{ψ}_{ⱼ} ({ [symbol] } [symbol] _{<j}) |
| 5: | : += log(P_{ψ}_{ⱼ} + (gᵢⱼ + 0.5)(1 − P_{ψ}_{ⱼ})) |
| 6: | end for |
| 7: | end for |
| 8: | w := z > 0 |
| 9: | return to |

This example, as previously, involves summing score contributions based on the determined values of the pseudorandom function over each of the predetermined number of watermarking stages, and each subsequence of the set of sub-sequences, to determine the watermarking score, w. The summed score contributions are log contributions that can include an adjustment factor, P_{ψj} that modulates the effect of biased g-values on the likelihood. The watermarking score is compared with a threshold, z, that depends on a prior probability that the sequence of tokens is watermarked, in particular

$$z = log ( \frac{P ( w )}{1 - P ( w )} ) .$$

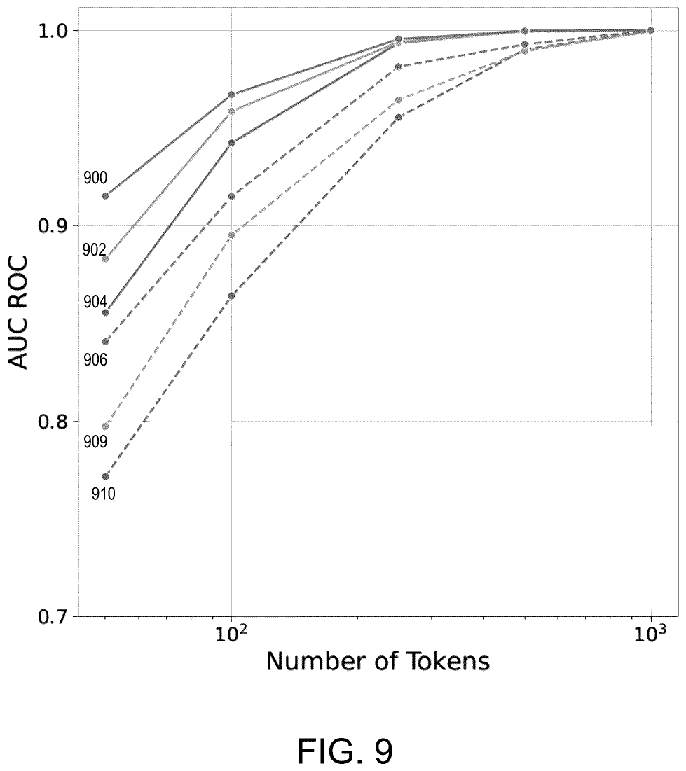

FIG. 9 shows a graph of the detectability of a watermark as indicated by AUC ROC (area under the receiver operating characteristic curve) against the number of tokens in a sequence. FIG. 9 compares implementations of the described techniques with Bayesian detection 900, 906 and with p-value based detection 902, 908, against another approach 904, 910 based on sampling using the Gumbel-trick (the lower three curves are for a larger language model than the upper three curves).

### Speculative Sampling

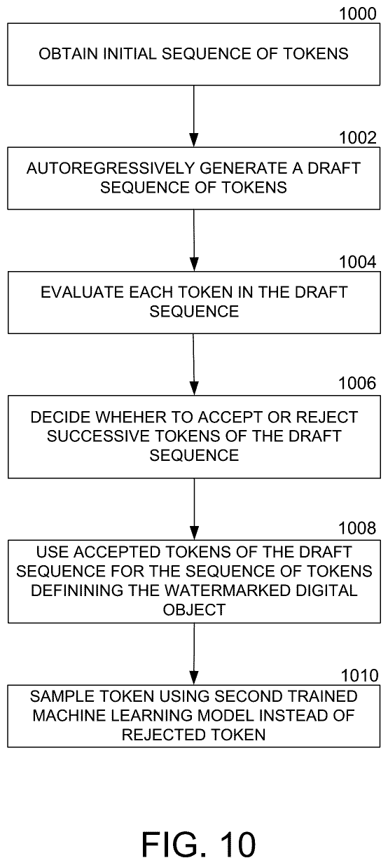

FIG. 10 is a flow diagram of a third example process for generating watermarking a digital object defined by a sequence of tokens. The process of FIG. 10 can be performed by a system of one or more computers located in one or more locations, e.g., by the generative machine learning system 100 of FIG. 1.

At step 1000 the process obtains an initial sequence of tokens to be extended as described below. This could be an initial prompt sequence, or a partial watermarked sequence for the digital object, or both. The initial sequence of tokens may be denoted x₁, . . . , xₙ (here n is typically different to the previously referred to n-gram).

The initial sequence of tokens is processed using a first, draft trained machine learning model (p(·|·)) to autoregressively generate a draft sequence of tokens (step 1002). At each of a series of time steps the initial sequence of tokens and previously generated tokens of the draft sequence are processed using the first, draft trained machine learning model to generate a draft probability distribution that is modified to generate a watermarked draft probability distribution (\tilde{p}_{g}(·|·); \tilde{p}_{g′}(·|·)). Then a current draft token (\tilde{x}ₜ) is sampled from the watermarked draft probability distribution, e.g., as \tilde{x}ₜ˜\tilde{p}_{g}(·|x₁, . . . , xₙ, \tilde{x}₁, . . . , \tilde{x}ₜ₋₁) or \tilde{x}ₜ˜\tilde{p}_{g′}(·|x₁, . . . , xₙ, \tilde{x}₁, . . . , \tilde{x}ₜ₋₁).

The watermarked draft probability distribution can be generated from the draft probability distribution as previously described, but implementations of the technique do not rely on this and other watermarking methods can also be used. Merely as examples, some other watermarking techniques that can be used are described in Kuditipudi et al. arXiv:2307.15593; Kirchenbauer et al., arXiv:2301.10226 and arXiv:2306.04634; Christ et al. arXiv:2306.09194; and Hu et al. arXiv:2310.10669.

Each of the tokens of the draft sequence is evaluated using one or more instances of a second trained machine learning model (q(·|·)) (step 1004). In implementations the second trained machine learning model has more learned parameters, e.g., weights, than the first, draft trained machine learning model. The first, draft trained machine learning model can be faster than the second trained machine learning model, but may be less powerful.

In some implementations the evaluation is performed in parallel; this can result in an approximate doubling of the speed of generating the watermarked digital object. More specifically a respective instance of the second trained machine learning model for each of the tokens to be evaluated can be implemented on parallel computing hardware. Each of the tokens of the draft sequence can then be evaluated in parallel on the parallel computing hardware using the respective instances of the second trained machine learning model.

In general the evaluation involves processing the initial sequence of tokens and the draft sequence of tokens up to the evaluated token using the second trained machine learning model to determine either a second model probability distribution (q(·|·)) or a watermarked second model probability distribution, i.e., a watermarked version of the second model probability distribution (\tilde{q}_{g}(·|·)). The determined probability distribution may be expressed, e.g., as a set of scores or logits.

For example, in some implementations the evaluation may involve determining K watermarked second model probability distributions, e.g., sets of logits, \tilde{q}_{g}(·|x₁, . . . , xₙ), \tilde{q}_{g}(·|x₁, . . . , xₙ, \tilde{x}₁), . . . , \tilde{q}_{g}(·|x₁, . . . , xₙ, \tilde{x}₁, . . . , \tilde{x}_{K-1}). Optionally an additional watermarked second model probability distribution, \tilde{q}_{g}(·|x₁, . . . , xₙ, \tilde{x}₁, . . . , \tilde{x}_{K}) may be determined that can be used for sampling an additional token for the extended sequence if all the draft tokens are accepted (described later).

In some implementations the evaluation may involve determining K (unwatermarked) second model probability distributions, e.g., sets of logits, q(·|x₁, . . . , xₙ), q(·|x₁, . . . , xₙ, \tilde{x}₁), . . . , q(·|x₁, . . . , xₙ, \tilde{x}₁, . . . , \tilde{x}_{K-1}). Again optionally an additional unwatermarked second model probability distribution, q(·|x₁, . . . , xₙ, \tilde{x}₁, . . . , \tilde{x}_{K}) may be determined, e.g., defined by an additional set of logits.

For each successive token of the draft sequence a decision, in particular a stochastic decision, can be made whether to accept or reject the token of the draft sequence (step 1006).

In some implementations this is done by comparing a probability of the token according to the watermarked draft probability distribution for the initial sequence of tokens and the draft sequence of tokens up to the preceding token, and a probability of the token according to the watermarked second model probability distribution for the initial sequence of tokens and the draft sequence of tokens up to the preceding token.

In some implementations this can be done by comparing a probability of the token according to the draft probability distribution for the initial sequence of tokens and the draft sequence of tokens up to the preceding token, and a probability of the token according to the second model probability distribution for the initial sequence of tokens and the draft sequence of tokens up to the preceding token.

In implementations the probabilities are compared by determining a ratio of one to the other, and in implementations the decision is a stochastic decision. That is whether to accept or reject the token of the draft sequence can be determined stochastically, e.g., according to a probability set by the ratio.

As one example, for a draft token xₜ, and for n=t−1, the process can determine the ratio

$$\frac{{\tilde{q}}_{g} ( {x}_{t} \vert {x}_{1} , … , {x}_{n} )}{{\tilde{p}}_{g} ( {x}_{t} \vert {x}_{1} , … , {x}_{n} )}$$

and can determine whether to accept the token of the draft sequence with probability

$$min ( 1 , \frac{{\tilde{q}}_{g} ( {x}_{t} \vert {x}_{1} , … , {x}_{n} )}{{\tilde{p}}_{g} ( {x}_{t} \vert {x}_{1} , … , {x}_{n} )} )$$

As another example for a draft token xₜ, and for n=t−1, the process can determine the ratio

$$\frac{q ( {x}_{t} \vert {x}_{1} , … , {x}_{n} )}{p ( {x}_{t} \vert {x}_{1} , … , {x}_{n} )}$$

and can determine whether to accept the token of the draft sequence with probability

$$min ( 1 , \frac{q ( {x}_{t} \vert {x}_{1} , … , {x}_{n} )}{p ( {x}_{t} \vert {x}_{1} , … , {x}_{n} )} )$$

The rejection test can be run with watermarked or unwatermarked probability distributions. Running the rejection test with watermarked probability distributions maintains watermark detectability and preserves the unwatermarked distribution, but can reduce the acceptance rate of draft tokens, and can hence result in a process that overall runs more slowly. Running the rejection test with unwatermarked probability distributions allows the process to run faster, at the cost of reduced watermark detectability.

The series of successively accepted tokens of the draft sequence is used for the sequence of tokens defining the watermarked digital object, up to where a token of the draft sequence is rejected (step 1008).

At the point where a token of the draft sequence is rejected, instead of using the rejected token, the next token (for the sequence of tokens defining the watermarked digital object) is selected using the second trained machine learning model (step 1010).

Optionally one additional token for extending the sequence of tokens defining the watermarked digital object can then be obtained by sampling from the additional watermarked second model probability distribution described earlier, e.g., from the additional set of logits.

Once the sequence of tokens defining the watermarked digital object has been extended as described above, typically using one or more tokens from the draft sequence, the extended sequence can be used as the initial sequence of tokens for a subsequent iteration of the process (step 1012).

In general selecting the next token for the sequence of tokens defining the watermarked digital object using the second trained machine learning model involves sampling the next token from a probability distribution defined by a difference between the watermarked second model probability distribution and a watermarked version of the draft probability distribution.

In some implementations the probability distribution is defined by a difference between the watermarked second model probability distribution and the watermarked draft probability distribution. In some implementations the probability distribution is defined by a difference between the watermarked second model probability distribution and a different watermarked version of the draft probability distribution (to the watermarked draft probability distribution), e.g., one defined by a different set of keys. This latter approach can be used, e.g., where the rejection test is run with unwatermarked probability distributions.

More particularly, in some implementations the probability distribution is defined by a difference between the watermarked second model probability distribution and the watermarked draft probability distribution according to

$${( q - p )}_{g}^{+} ( {x}_{1} , … , {x}_{n} ) := {( {\tilde{q}}_{g} ( \cdot \vert {x}_{1} , … , {x}_{n} ) - {\tilde{p}}_{g} ( \cdot \vert {x}_{1} , … , {x}_{n} ) )}_{+}$$

where (·)₊ denotes the positive part, optionally normalized, e.g., according to (ƒ(x))₊=max(0,ƒ(x))/Σₓ max(0,ƒ(x)).

In some implementations the probability distribution is defined by a difference between the watermarked second model probability distribution and the different watermarked version of the draft probability distribution according to

$${( q - p )}_{g ″}^{+} ( {x}_{1} , … , {x}_{n} ) := {( {\tilde{q}}_{g ″} ( \cdot \vert {x}_{1} , … , {x}_{n} ) - {\tilde{p}}_{g ″} ( \cdot \vert {x}_{1} , … , {x}_{n} ) )}_{+}$$

where \tilde{X}_{g″}(·|·) denotes a watermarking based on a different pseudorandom function or key to \tilde{X}_{g′}(·|·) (or to \tilde{X}_{g}(·|·)).

For example modifying the draft probability distribution to generate a watermarked draft probability distribution can involve modifying the draft probability distribution using a cryptographic function (g′) dependent on one or more first keys. The second model probability distribution can be modified using the same cryptographic function dependent on one or more second keys different to the one or more first keys (g″) to generate the watermarked second model probability distribution. Optionally the draft probability distribution can be modified using the same cryptographic function dependent on the one or more second keys (g″) to generate the watermarked version of the draft probability distribution used in combination with the watermarked second model probability distribution when selecting the next token using the second trained machine learning model.

That is, in broad terms, implementations of this approach can use two separate keys (or sets of keys), one for sampling the draft tokens and another for sampling tokens when a draft token is rejected. Thus in such implementations there can be two different (independent) watermarking (pseudorandom) functions, g′ and g″ in the above nomenclature.

As previously mentioned, in some implementations, but not necessarily, the watermarking can use a process as previously described.

Thus in some implementations the draft probability distribution can be modified to generate the watermarked draft probability distribution using a cryptographic function dependent on a key. The cryptographic function can be applied to the draft probability distribution at each of a plurality of watermarking stages, each watermarking stage using a different respective key, to generate the watermarked draft probability distribution.

The second model probability distribution can be modified using the same cryptographic function dependent on a key to generate the watermarked second model probability distribution, by applying the cryptographic function to the second model probability distribution at each of a plurality of watermarking stages, each watermarking stage using a different respective key, to generate the watermarked second model probability distribution. As previously mentioned this can use the second keys, different to the first keys, which can be used for generating the draft sequence of tokens.

In implementations where it is used the different watermarked version of the draft probability distribution can be obtained by modifying the draft probability distribution using the same cryptographic function, by applying the cryptographic function to the draft model probability distribution at each of a plurality of watermarking stages, each watermarking stage using a different respective key. As previously mentioned this can use the second keys.

A first particular example of algorithm for generating a watermarked sequence of tokens defining a digital object according to the above described techniques is:

| | |
|---|---|
| 1: | Given lookahead K and minimum target sequence length T. |
| 2: | Given auto-regressive target model q(.\|.), and auto-regressive draft model p(.\|.), |
| | initial prompt sequence x₁, . . ., xₜ, g-function g = (g₁, . . ., gₘ), |
| 3: | Initialise n ← t. |
| 4: | while n < T do |
| 5: | for t = 1 : K do |
| 6: | Sample draft auto-regressively \tilde{x}ₜ ~ \tilde{p}_{g}(•\|\tilde{x}₁, . . . ,\tilde{x}ₙ, \tilde{x}₁, . . . , \tilde{x}ₜ₋₁) |
| 7: | end for |
| 8: | In parallel, compute K + 1 setts of logits from drafts \tilde{x}₁, . . . , \tilde{x}_{K} : |
| | \tilde{q}_{g}(•\|x₁, . . . , xₙ), \tilde{q}_{g}(•\|x₁, . . . ,xₙ, \tilde{x}₁), ..., \tilde{q}_{g}(•\|x₁, . . . , xₙ, \tilde{x}₁, . . . , \tilde{x}_{K} ) |
| 9: | for t = 1 : K do |
| 10: | Sample r ~ U[0, 1] from a uniform distribution. |
| 11: | if r < min (1, \tilde{q}_{g}(\tilde{x}ₜ\|x₁, . . . , xₙ)/\tilde{p}_{g} (\tilde{x}₁\|x₁, . . . , xₙ)) then |
| 12: | Set xₙ₊₁ ← \tilde{x}ₜ and n ← n + 1 |
| 13: | else |
| 14: | Sample xₙ₊₁ ~ (\tilde{q}_{g}(•\|x₁, . . . , xₙ) − \tilde{p}_{g}(•\|x₁, . . . , xₙ))₊ and n ← n + 1 |
| 15: | Exit for loop. |
| 16: | end if |
| 17: | end for |
| 18: | If all tokens \tilde{x}₁, . . . , \tilde{x}_{K} are accepted, sample extra |
| | token xₙ₊₁ ~ \tilde{q}_{g}(•\|x₁, . . . , xₙ)) and set n ← n + 1 |
| 19: | end while |

A second particular example of algorithm for generating a watermarked sequence of tokens defining a digital object according to the above described techniques is:

| | |
|---|---|
| 1: | Given lookahead K and minimum target sequence length T. |
| 2: | Given auto-regressive target model q(.\|.), |
| | and auto-regressive draft model p(.\|.), initial prompt |
| | sequence x₁, . . . , xₜ, two g-functions: g′ = (g₁, . . . , gₘ) and g″ = gₘ₊₁, . . . , g2ₘ). |
| 3: | Initialise n ← t. |
| 4: | while n < T do |
| 5: | for t = 1 : K do |
| 6: | Sample draft auto-regressively \tilde{x}ₜ ~ \tilde{p}_{g′}(•\|x₁, . . . , xₙ, \tilde{x}₁, . . . , \tilde{x}ₜ₋₁) |
| 7: | end for |
| 8: | In parallel, compute K + 1 sets of logits from drafts \tilde{x}₁, . . . , \tilde{x}_{K} : |
| | q(•\|x₁, . . . , x₂), q(•\|x₁, . . . , xₙ, \tilde{x}₁), ..., q(•\|x₁, . . . , xₙ, \tilde{x}₁, . . . , \tilde{x}_{K} ) |
| 9: | for t = 1 : K do |
| 10: | Sample r ~ U[0, 1] from a uniform distribution. |
| 11: | if r < min (1, q(\|x_{≤n})/p (•\|x_{≤n})) then |
| 12: | Set xₙ₊₁ ← \tilde{x}₁ and n ← n + 1 |
| 13: | else |
| 14: | Sample xₙ₊₁ ~ ( [symbol] [symbol] (•\|x_{≤n}), and n ← n + 1 |
| 15: | Exit for loop. |
| 16: | end if |
| 17: | end for |
| 18: | If all tokens \tilde{x}₁, . . . , \tilde{x}_{K} are accepted, sample extra |
| | token xₙ₊₁ ~ \tilde{q} [symbol] (•\|x₁, . . . , xₙ) and set n ← n + 1 |
| 19: | end while |

[symbol]

indicates data missing or illegible when filed

A watermark generated by these techniques can be detected as previously described.

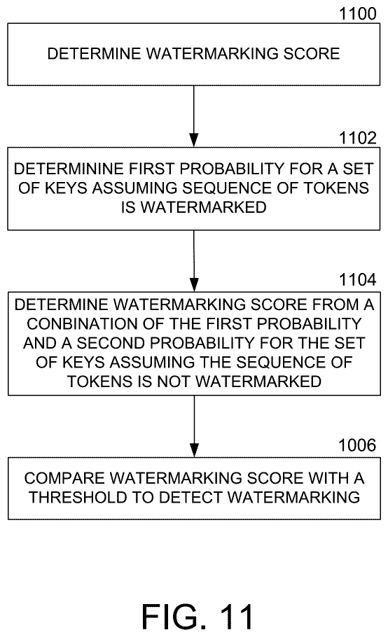

FIG. 11 is a flow diagram of a further example, Bayesian process for determining whether a digital object defined by a sequence of tokens is watermarked. The process of FIG. 11 is adapted to watermarking that has been generated using two different watermarking functions, g₁ and g₂, e.g., using two different sets of keys. The process of FIG. 11 can be performed by a system of one or more computers located in one or more locations.

The process involves determining a watermarking score for the digital object (step 1100), and comparing the watermarking score with a threshold to detect watermarking of the digital object (step 1106).

In implementations determining the watermarking score for the digital object involves determining a first probability of a set of keys used to generate the watermarked draft probability distribution given the sequence of tokens and assuming the sequence of tokens is watermarked (step 1102).

For example the first probability, P(g₁, g₂|w), can be determined as

$$P ( {g}_{1} , {g}_{2} \vert w ) = P ( {g}_{1} \vert w , k = {k}_{1} ) P ( {g}_{2} \vert ¬ w ) P ( accept ) + P ( {g}_{2} \vert w , k = {k}_{2} ) P ( {g}_{1} \vert ¬ w ) [ 1 - P ( accept ) ]$$

where the keys k are explicitly denoted k₁ and k₂, P(g₁|¬w) and P(g₂|¬w) are as before, and P(accept) can be determined empirically, e.g., learned. A value for P(gᵢ|w, k=kᵢ) or, in more detail, for P(gᵢⱼ|w, {gᵢₗ}_{t<j}) can be determined as:

$${P ( {g}_{ij} \vert w , {\{ {g}_{i ℓ} \}}_{ℓ < j} ) = {\sum }_{c = 1}^{2} P ( {g}_{ij} \vert w , {\{ {g}_{i ℓ} \}}_{ℓ < j} , {ψ}_{j} = c ) P ( {ψ}_{j} = c \vert {\{ {g}_{i ℓ} \}}_{ℓ < j} ) P ( \{ {g}_{i ℓ} ) \}}_{ℓ < j}$$

where symbols have their previous meanings, for example where P_{ψj=1}=P(ψⱼ=1|{gᵢₗ}_{t<j})P({gᵢₗ}_{t<j}) is learnable latent complementary to P_{ψj=2}.

In implementations the process determines the watermarking score from a combination of the first probability and a second probability (step 1104). The second probability is a probability of the set of keys used to generate the watermarked draft probability distribution given the sequence of tokens and assuming the sequence of tokens is not watermarked.

As an example the second probability P(g₁, g₂|¬w) can be determined as P(g₁, g₂|¬w)=P(g₁|¬w)P(g₂|¬w) or, in more detail P(g_{ij,1}, g_{ij,2}|¬w)=P(g_{ij,1}|¬w)P (g_{ij,2}|¬w). The second probability can be a fixed value for a particular implementation (and sequence length); in some implementations it may not be determined explicitly. As an example the watermarking score, P(w|g₁, g₂), can be determined according to:

$$P ( w \vert {g}_{1} , {g}_{2} ) = \frac{P ( {g}_{1} , {g}_{2} \vert w ) P ( w )}{P ( {g}_{1} , {g}_{2} \vert w ) P ( w ) + P ( {g}_{1} , {g}_{2} \vert ¬ w ) P ( ¬ w )}$$

where prior probabilities P(w)+P(¬w)=1. In practice the prior probabilities may be incorporated into the threshold to detect watermarking of the digital object.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The typical elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method of watermarking a digital object, wherein the digital object is defined by a sequence of tokens, the method comprising:
generating each token of the sequence of tokens by:
processing preceding tokens in the sequence, using a trained machine learning model, to determine an initial probability distribution over possible tokens for a current token in the sequence; and
selecting the current token in the sequence in accordance with a modified probability distribution over the possible tokens; wherein
selecting the current token in the sequence in accordance with the modified probability distribution comprises iteratively, for each of a plurality of watermarking stages:
applying, to a representation of, or to samples from, a probability distribution associated with the watermarking stage, a modification based on a respective pseudorandom function for the watermarking stage, wherein the pseudorandom function is a function of one or more of the preceding tokens in the sequence and a supposed current token; and wherein
the probability distribution associated with a first of the watermarking stages is the initial probability distribution, and the modification applied in a last of the watermarking stages results in a representation of, or sample from, the modified probability distribution.

2. The method of claim 1, comprising applying the modification to the samples from the probability distribution associated with the watermarking stage; and wherein applying the modification comprises selecting one or more of the samples from the probability distribution associated with the watermarking stage.

3. The method of claim 2 further comprising:
determining, for each of a plurality of tournament tokens, a value of the respective pseudorandom function for the watermarking stage, based on the one or more preceding tokens in the sequence and using the tournament token as the supposed current token,
wherein the tournament tokens comprise the samples from a probability distribution associated with the watermarking stage; and
selecting a subset of one or more of the tournament tokens based on the value of the respective pseudorandom function for each of the tournament tokens.

4. The method of claim 3, wherein determining the plurality of tournament tokens associated with the first of the watermarking stages comprises sampling from the initial probability distribution.

5. The method of claim 4, further comprising:
after the first of the watermarking stages, using the tournament tokens selected in the previous watermarking stage as the plurality of tournament tokens associated with the watermarking stage.

6. The method of claim 3, wherein selecting the current token in the sequence comprises:
selecting, for the last of the watermarking stages, one of the tournament tokens as the current token in the sequence.

7. The method of claim 1, comprising:
applying the modification based on the respective pseudorandom function to the representation of the probability distribution associated with each of the plurality of watermarking stages by, for each of the plurality of watermarking stages, modifying the representation of the probability distribution using the respective pseudorandom function; and
determining the modified probability distribution as a result of modifying the representation of the probability distribution in the last of the watermarking stages; and wherein
selecting the current token in the sequence comprises sampling from the modified probability distribution.

8. The method of claim 7, wherein the representation of the probability distribution comprises a set of scores, one for each of the possible tokens for the current token in the sequence, and wherein modifying the probability distribution using the respective pseudorandom function comprises:
determining a modified set of scores by:
determining a set of pseudorandom function values, one for each of the possible tokens for the current token in the sequence, each pseudorandom function value of the set of pseudorandom function values comprising a value of the respective pseudorandom function for the watermarking stage based on the one or more preceding tokens in the sequence and on one of the possible tokens as the supposed current token;
modifying each score of the set of scores using a corresponding one of the set of pseudorandom function values.

9. The method of claim 8 wherein determining the initial probability distribution comprises determining an initial set of scores using the trained machine learning model.

10. The method of claim 8, wherein modifying each score of the set of scores using a corresponding one of the set of pseudorandom function values comprises:
increasing each score of the set of scores, using a scaling factor based on a corresponding one of the set of pseudorandom function values and a normalizing term.

11. The method of claim 7, wherein modifying the representation of the probability distribution using the respective pseudorandom function includes constraining the modifying such that the probability distribution associated with the watermarking stage is unchanged when averaged over values of the respective pseudorandom function.

12. The method of claim 7, wherein the pseudorandom function has a binary value; or wherein the pseudorandom function has a continuous value.

13. The method of claim 1,
wherein the digital object comprises a portion of text, wherein the trained machine learning model comprises a trained language generation neural network, and wherein the tokens comprise natural language tokens from a vocabulary of possible natural language tokens; or
wherein the digital object comprises a still or moving image, wherein the trained machine learning model comprises a trained image generation neural network, and the tokens define pixels or regions of a generated image; or
wherein the digital object comprises data representing an audio waveform, wherein the trained machine learning model comprises a trained audio generation neural network, and the tokens define values, features, or regions of the audio waveform.

14. The method of claim 1, wherein the trained machine learning model is a first, draft trained machine learning model; wherein
processing preceding tokens in the sequence, using the trained machine learning model, to determine an initial probability distribution comprises processing preceding tokens in the sequence, using the first, draft trained machine learning model to determine the initial probability distribution; and wherein
selecting the current token in the sequence in accordance with the modified probability distribution over the possible tokens comprises:
selecting a current token of a draft sequence of tokens in accordance with the modified probability distribution;
processing preceding tokens in the sequence using a second trained machine learning model to determine a second model probability distribution;
determining whether to accept the selected current token of the draft sequence as the current token in the sequence of tokens defining the digital object by comparing either:
i) a probability of the selected current token according to the modified probability distribution and a probability of the selected current token according to a modified second model probability distribution that is a modified version of the second model probability distribution, or
ii) a probability of the selected current token according to the initial probability distribution and a probability of the selected current token according to the second model probability distribution; and
using the selected current token of the draft sequence as the current token in the sequence of tokens defining the digital object when the selected current token of the draft sequence is accepted, and
selecting the current token in the sequence of tokens defining the digital object using the second trained machine learning model when the selected current token of the draft sequence is rejected.

15. The method of claim 14, wherein selecting the current token in the sequence of tokens defining the digital object using the second trained machine learning model comprises:
sampling the current token in the sequence of tokens defining the digital object from a probability distribution defined by a difference between the modified second model probability distribution and the modified probability distribution.

16. The method of claim 15, wherein the difference between the modified second model probability distribution and the modified probability distribution is either:
i) the difference between the modified second model probability distribution obtained when each respective second model pseudorandom function is the same as the corresponding respective pseudorandom function, or
ii) the difference between the modified second model probability distribution obtained when each respective second model pseudorandom function is different to the corresponding respective pseudorandom function.

17. A computer-implemented method of detecting watermarking of a digital object, wherein the digital object is defined by a sequence of tokens, the method comprising:
determining a watermarking score for the digital object; and
comparing the watermarking score with a threshold to detect watermarking of the digital object; wherein
determining the watermarking score for the digital object comprises:
determining a set of sub-sequences of the sequence of tokens, each sub-sequence starting at a different respective token of the sequence of tokens;
for each of a predetermined number of watermarking stages: determining a value of a pseudorandom function associated with the watermarking stage for each subsequence of the set of sub-sequences; and
summing score contributions based on the determined values of the pseudorandom function over i) each of the predetermined number of watermarking stages, and ii) each subsequence of the set of sub-sequences, to determine the watermarking score.

18. The method of claim 17, wherein summing the score contributions includes applying a weighting according to the watermarking stage.

19. The method of claim 17, wherein the threshold depends on a prior probability that the sequence of tokens is watermarked.

20. A computer-implemented method of generating a watermarked digital object defined by a sequence of tokens, by extending an initial sequence of tokens, the method comprising:
processing the initial sequence of tokens using a first, draft trained machine learning model to autoregressively generate a draft sequence of tokens by, at each of a series of time steps:
processing the initial sequence of tokens and previously generated tokens of the draft sequence to generate a draft probability distribution,
modifying the draft probability distribution to generate a watermarked draft probability distribution, and
sampling a current draft token from the watermarked draft probability distribution;
evaluating each of the tokens of the draft sequence using one or more instances of a second trained machine learning model by:
processing the initial sequence of tokens and the draft sequence of tokens up to the evaluated token using the second trained machine learning model to determine either a second model probability distribution or a watermarked second model probability distribution that is a watermarked version of the second model probability distribution;
for each successive token of the draft sequence determining whether to accept the token of the draft sequence by comparing either:
i) a probability of the token according to the watermarked draft probability distribution for the initial sequence of tokens and the draft sequence of tokens up to the preceding token, and a probability of the token according to the watermarked second model probability distribution for the initial sequence of tokens and the draft sequence of tokens up to the preceding token, or
ii) a probability of the token according to the draft probability distribution for the initial sequence of tokens and the draft sequence of tokens up to the preceding token, and a probability of the token according to the second model probability distribution for the initial sequence of tokens and the draft sequence of tokens up to the preceding token; and
using the successive accepted tokens of the draft sequence for the sequence of tokens defining the watermarked digital object up to where a token of the draft sequence is rejected and selecting a next token for the sequence of tokens defining the watermarked digital object using the second trained machine learning model.

21. The method of claim 20, wherein selecting a next token for the sequence of tokens defining the watermarked digital object using the second trained machine learning model comprises:
sampling the next token from a probability distribution defined by a difference between the watermarked second model probability distribution and a watermarked version of the draft probability distribution.

22. The method of claim 21, wherein the watermarked version of the draft probability distribution is the watermarked draft probability distribution.

23. The method of claim 20, wherein
modifying the draft probability distribution to generate a watermarked draft probability distribution comprises modifying the draft probability distribution using a cryptographic function dependent on one or more first keys, the method further comprising:
modifying the second model probability distribution using the same cryptographic function dependent on one or more second keys different to the one or more first keys to generate the watermarked second model probability distribution; and
modifying the draft probability distribution using the same cryptographic function dependent on the one or more second keys to generate the watermarked version of the draft probability distribution.

24. The method of claim 20, wherein the second trained machine learning model has more learned parameters than the first, draft trained machine learning model.

25. The method of claim 20, further comprising:
for each of the tokens of the draft sequence implementing a respective instance of the second trained machine learning model on parallel computing hardware; and
evaluating each of the tokens of the draft sequence in parallel on the parallel computing hardware using the respective instances of the second trained machine learning model.

26. The method of claim 20, wherein
modifying the draft probability distribution to generate a watermarked draft probability distribution comprises modifying the draft probability distribution using a cryptographic function dependent on a key, the method further comprising:
modifying the second model probability distribution using the same cryptographic function dependent on a key to generate the watermarked second model probability distribution; and wherein
modifying the draft probability distribution comprises applying the cryptographic function to the draft probability distribution at each of a plurality of watermarking stages, each watermarking stage using a different respective key, to generate the watermarked draft probability distribution; and
modifying the second model probability distribution comprises applying the cryptographic function to the second model probability distribution at each of a plurality of watermarking stages, each watermarking stage using a different respective key, to generate the watermarked second model probability distribution.
